(19) United States
(12) Patent Application Publication
(10) Pub. No.: US 2012/0134346 A1
(43) Pub. Date: May 31, 2012

(54) WIRELESS COMMUNICATION SYSTEM NETWORK EQUIPMENT WITH BROADCAST-BASED BACKHAUL NETWORK INTERFACE AND NEXT GENERATION AIR INTERFACE

(76) Inventors: Peter Bosch, Aalsmeer (NL); Karl Georg Hampel, New York, NY (US); Indra Widjaja, Roseland, NJ (US)

(21) Appl. No.: 12/956,620

(22) Filed: Nov. 30, 2010

(51) Int. Cl. H04W 4/00; H04W 72/04

(52) U.S. Cl. 370/338; 370/329

(57) ABSTRACT

Network equipment of a wireless communication system comprises a backhaul interface for communicating with a broadcast-based backhaul network and an air interface for communicating with a plurality of mobiles. The network equipment is configured to serve as a proxy on the broadcast-based backhaul network for at least a given one of the mobiles that communicates with the network equipment over the air interface, by determining an IP address for the given mobile and sending a broadcast message over the broadcast-based backhaul network advertising itself as the proxy in association with the IP address. The network equipment may comprise at least a portion of a base station of the wireless communication system. The broadcast-based backhaul network may comprise a local area network that operates in accordance with an Ethernet protocol, and the air interface may comprise an LTE air interface or a WiMAX air interface.

### FIELD OF THE INVENTION

The present invention relates generally to wireless communication systems, and more particularly to techniques for providing improved mobility management in such systems.

### BACKGROUND OF THE INVENTION

A wireless local area network (LAN) typically comprises a LAN or virtual LAN (VLAN) that interconnects multiple IEEE 802.11 (WiFi) access points with one or more Layer 2/Layer 3 (L2/L3) gateways (GWs). In most cases, the LAN uses the Ethernet protocol, which is based on IEEE 802.1 and IEEE 802.3 standards. The GWs form the portal to an L3 network, such as the Internet.

The Ethernet protocol of the LAN permits dynamic path establishment and path updates via flooding and learning. This allows mobile users to sustain their connections while moving from one access point to the next. Since the flooding mechanism is based on broadcast, all bridges and routers on the LAN update the new path based on one signaling message. The LAN does not require additional functions for mobility management. This makes network design easier and it lowers the cost for network components. Further, high reliability and fast recovery in case of network-node failure can be supported through auto-configuration protocols like the Rapid Spanning Tree Protocol (RSTP).

LANs usually do not scale very well due to the broadcast-based signaling of the Ethernet protocol. The high capacity of present Ethernet devices, however, allows expanding such networks to sizeable areas and levels of traffic. Thus, WiFi access points connected via a broadcast-based network such as a LAN provide a very low cost mobility solution for enterprise or municipal deployments.

Wireless communication standards are currently evolving from third generation (3G) standards to fourth generation (4G) standards. For example, in the cellular context, standards are currently evolving from 3G standards such as the UMTS standard promulgated by the 3G Partnership Project (3GPP) and the EVDO standard promulgated by 3G Partnership Project 2 (3GPP2), to 4G standards generally referred to as Long Term Evolution (LTE) standards. Another example of a 4G standard includes IEEE 802.16 (WiMAX), which specifies the air interface of combined fixed and mobile point-to-multipoint broadband wireless access (BWA) systems providing multiple services.

The above-noted 4G wireless technologies such as LTE or WiMAX provide a superior air interface relative to WiFi, with wider range, better bandwidth efficiency and quality of service (QoS) support. They further support idle-mode management and paging, which are not available for WiFi. However, 4G wireless technologies require a local mobility anchor to facilitate local mobility management. Important functions of this local mobility anchor are tunnel management and tasks related to idle-mode management. The local mobility anchor is implemented as a specialized network node, referred to as a service GW (S-GW) in LTE and an access service network GW (ASN-GW) in WiMAX. The need for this specialized network node makes the system more complex and expensive. Also, transport is handled through bandwidth-inefficient tunnels rather than direct packet forwarding as used in wireless LANs. Other known mobility protocols, such as Mobile IP or Host Identifier Protocol (HIP), are similarly deficient in that they generally either require mobility anchors or are host-based and require an Internet Protocol (IP) address change at every mobility event.

### SUMMARY OF THE INVENTION

Illustrative embodiments of the present invention overcome one or more of the above-noted drawbacks of conventional practice by providing a wireless communication system in which a given base station or other network equipment includes a backhaul interface to a broadcast-based network such as a LAN operating in accordance with an Ethernet protocol, and an air interface such as an LTE air interface or a WiMAX air interface.

In accordance with one embodiment of the invention, network equipment of a wireless communication system comprises a backhaul interface for communicating with a broadcast-based backhaul network and an air interface for communicating with a plurality of mobiles. The network equipment is configured to serve as a proxy on the broadcast-based backhaul network for at least a given one of the mobiles that communicates with the network equipment over the air interface, by determining an IP address for the given mobile and sending a broadcast message over the broadcast-based backhaul network advertising itself as the proxy in association with the IP address. The network equipment may comprise at least a portion of a base station of the wireless communication system. The broadcast-based backhaul network may comprise a local area network that operates in accordance with an Ethernet protocol, and the air interface may comprise an LTE air interface or a WiMAX air interface.

In at least one of the illustrative embodiments, the network equipment is configured to support both idle mode and active mode functionality on the air interface for the given mobile. For example, the network equipment may be configured to permit a data delivery path to be established to the given mobile regardless of whether that mobile is in an active state or an idle state. More particularly, the network equipment may be configured to respond to an additional broadcast message from other network equipment connected to the broadcast-based backhaul network in order to establish the data delivery path to the given mobile in its active state or idle state.

Advantageously, one or more of the illustrative embodiments can provide the advantages of 4G air interface technologies in a wireless LAN or other type of broadcast-based backhaul network. For example, these embodiments do not require mobility anchors, nor do they require an IP address change at every mobility event. Data traffic can be forwarded directly, without the need for bandwidth-inefficient tunnels. Also, the disclosed techniques are compliant with standard 4G air interfaces, such as LTE or WiMAX, and therefore no changes are required to the mobiles.

These and other features and advantages of the present invention will become more apparent from the accompanying drawings and the following detailed description.

### BRIEF DESCRIPTION OF THE DRAWINGS

FIG. 1A is a block diagram of a communication system in an illustrative embodiment of the invention.

FIG. 1B shows exemplary mobility management functional elements as well as circuitry elements associated with a given base station of the system of FIG. 1A in an illustrative embodiment.

FIG. 2 shows a more detailed view of user equipment, base station, gateway and other system elements in one possible LTE implementation of the FIG. 1A system.

FIGS. 3 through 6 are signal flow diagrams showing exemplary communications between the system elements of the LTE implementation of FIG. 2.

FIG. 7 shows an exemplary protocol stack for the user equipment, base station and gateway elements of the LTE implementation of FIG. 2.

### DETAILED DESCRIPTION OF THE INVENTION

The present invention will be illustrated herein in conjunction with exemplary communication systems and associated techniques for configuring a base station or other network equipment to support a broadcast-based backhaul network and a wireless 4G air interface. It should be understood, however, that the invention is not limited to use with the particular types of communication systems and interface arrangements disclosed. The invention can be implemented in a wide variety of other communication systems, using alternative communication protocols. For example, although illustrated primarily in the context of an LTE wireless cellular air interface, the disclosed techniques can be adapted in a straightforward manner to a number of other types of next generation air interfaces, including a WiMAX air interface.

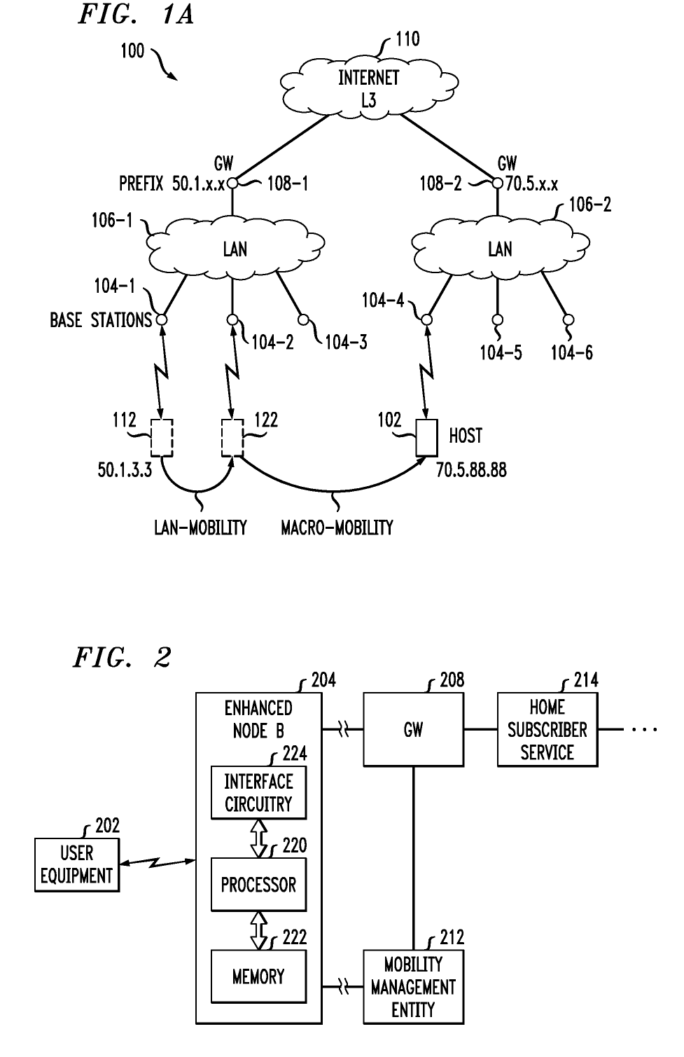

FIG. 1A shows a communication system 100 comprising a mobile 102, base stations 104, local area networks (LANs) 106, gateways (GWs) 108 and an L3 network such as Internet 110. The mobile 102 may comprise, for example, a mobile telephone, a portable computer, or any other type of communication device. The mobile 102 generally has at least two modes of operation, including an active mode and an idle mode. The base stations 104 are each coupled to one of the LANs 106, which are each connected via a corresponding one of the GWs 108 to Internet 110. More specifically, base stations 104-1, 104-2 and 104-3 are coupled to LAN 106-1 which is coupled to Internet 110 via GW 108-1, and base stations 104-4, 104-5 and 104-6 are coupled to LAN 106-2 which is coupled to Internet 110 via GW 108-2.

A given one of the base stations 104 may be viewed as an example of what is more generally referred to herein as “network equipment.” Such network equipment in other embodiments may comprise, for example, a portion of a base station, or a base station or portion thereof in combination with one or more other system elements.

The interface between a given base station 104 and its corresponding LAN 106 is an example of what is more generally referred to herein as a “backhaul interface.” The LAN 106 may be viewed as representing an example of at least a portion of what is more generally referred to as a “broadcast-based backhaul network.”

In the particular arrangement shown in FIG. 1A, the mobile 102 is assumed to move from position 112 where it communicates with base station 104-1, to position 122 where it communicates with base station 104-2, and finally to its current position where it communicates with base station 104-4. Movement from position 112 to position 122, both illustratively shown as the mobile 102 in dashed outline, is an example of LAN-mobility, since the corresponding base stations are both coupled to the same LAN 106-1. The movement of the mobile from position 122 to its current position is an example of macro-mobility, since the mobile 102 in that position communicates with base station 104-4 that is coupled to LAN 106-2. It can be seen that the IP address of the mobile when associated with positions 112 and 122 is 50.1.3.3, based on the prefix 50.1.x.x of GW 108-1. The IP address of the mobile 102 in its current position changes to 70.5.88.88, based on the prefix 70.5.x.x of the GW 108-2.

Each of the LANs 106 thus represents a domain space (DS) supporting a specific prefix. All mobiles attached to base stations within this domain hold IP addresses compliant with the associated prefix. Mobiles can therefore move freely within the DS from one base station to another without changing their IP addresses.

The LANs provide dynamic path establishment and path update capabilities through broadcast-based techniques, such as through the Address Resolution Protocol (ARP) disclosed in IETF RFC 826, which is incorporated by reference herein. The LANs can be implemented using the Ethernet protocol as described in the IEEE 802.1 and 802.3 standards. In such an Ethernet implementation, only the base stations 104 and the GWs 108 will typically have L3 routing functionality and hold routing entries for the mobiles.

The present embodiment of communication system 100 is therefore advantageously configured such that the base stations 104 implement mobility management functionality that does not require mobility anchors or an IP address change at every mobility event. This functionality allows packets destined for and originated by mobiles to be forwarded directly on the corresponding LAN 106, and thus without the need for tunnels. The system 100 thus provides base stations that support a standards-compliant 4G air interface and a low-cost Ethernet-based backhaul network.

As indicated above, the dynamic path establishment and update capabilities of the LAN are utilized to switch delivery paths for mobiles that change their attachment point to the system, such that no dedicated mobility anchor is needed and transport can occur directly without tunnels. Furthermore, all traffic may be routed directly within the LAN using the shortest path. Idle mode and active mode mobility management is provided at least in part by implementing mobility management functionality within the base stations. Some remaining control-plane functions associated with mobility management can be held centrally or distributed over the base stations. Examples of these control-plane functions include paging control, key management and location management. In LTE, these functions typically reside on a mobility management entity (MME). Embodiments of the present invention introduce flexibility with respect to where these functions reside.

The FIG. 1A arrangement is just one exemplary configuration of a communication system comprising a wireless LAN with a 4G air interface, and numerous alternative configurations of system elements may be used. For example, a given alternative embodiment of the invention may of course include larger numbers of mobiles, base stations, LANs and gateways, as well as additional or alternative elements of a type commonly associated with conventional system implementations.

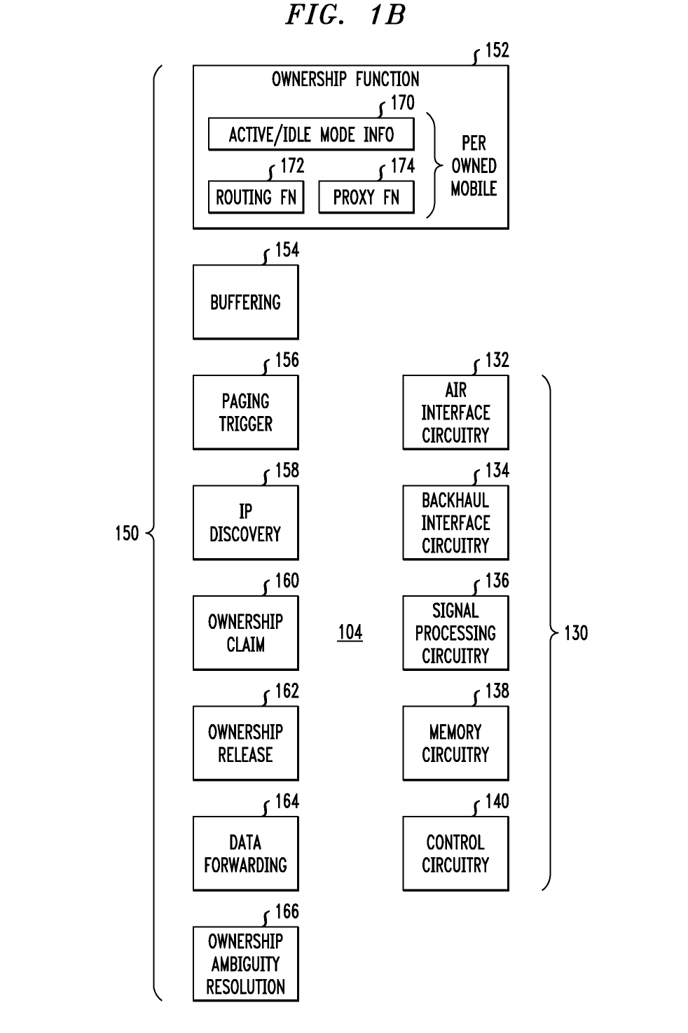

FIG. 1B shows certain elements of a given one of the base stations 104 in the present embodiment. The elements shown include circuitry elements 130, illustratively comprising air interface circuitry 132, backhaul interface circuitry 134, signal processing circuitry 136, memory circuitry 138, and control circuitry 140. The interface circuitry elements 132 and 134 may comprise conventional transceivers utilized to communicate over an air interface and a backhaul network interface, respectively. Signal processing circuitry 136 may comprise one or more digital signal processors (DSPs), field-programmable gate arrays (FPGAs), or other types of conventional circuitry utilized for processing of signals received or transmitted by the base station. The memory circuitry 138 and control circuitry 140 may comprise respective memory and processor elements, more detailed examples of which are described in conjunction with elements 220 and 222 of FIG. 2.

The base station 104 also implements a number of mobility management functional elements 150, which support interoperability between its air interface with mobiles 102 and its backhaul interface with a corresponding one of the LANs 106. These mobility management functional elements 150 in the illustrative embodiment include an ownership function 152 which applies to a subset of active-mode and idle-mode mobiles of the system that are unambiguously “owned” by the base station, a buffering function 154 which applies to arriving data for idle-mode mobiles in the subset, a paging trigger function 156 to generate triggers for a paging controller that may be part of control circuitry 140, an IP discovery function 158 to identify the IP address of a mobile upon its association with the base station, an ownership claim function 160 exercised through a generic broadcast message on the LAN, a subsequent ownership release function 162, a data forwarding function 164 which is applied to the buffered data, and an ownership ambiguity resolution function 166.

Each of the above-listed mobility management functional elements 150 will be described in greater detail below. These functional elements may be viewed as examples of what are more generally referred to herein as “modules.” One or more of these modules may be implemented at least in part utilizing circuitry elements of base station 104, such as memory circuitry 138 and control circuitry 140.

Ownership Function

The ownership function 152 of base station 104 unambiguously maps each registered mobile of the subset to that base station. For such mobiles, the base station owner holds all operational responsibilities as well as proxies for those mobiles on the corresponding LAN 106. All mobility-related events such as active-mode handover, tracking area update (TAU) or session initiation in idle mode are translated into an ownership switch between base stations. The ownership switch, realized through the ownership claim and ownership release functions to be described in detail below, is exercised via the above-noted generic broadcast message on the LAN, and updates the data path for the mobile at the same time. This advantageously eliminates the need for mobility-related anchors.

For each of the mobiles associated with the base station 104, the ownership function 152 comprises an active/idle mode information cache 170, a routing function 172, and a proxy function 174. The routing function 172 is exercised by the owning base station on behalf of the corresponding mobile when that mobile is in its active mode. This function routes traffic originated by the mobile on the air interface to the backhaul interface and vice versa. The routing function holds a cache of the routing entry on behalf of the mobile on both interfaces. The proxy function 174 is exercised by the base station on behalf of the corresponding mobile on the backhaul interface. This proxy function provides the L2 or L3 address of the base station upon requests for the L3 address of the mobile arriving at the backhaul interface. The above-noted ARP or another suitable protocol may be used for such messages.

Through the ownership function 152, each mobile in the network, idle or active, is unambiguously owned by exactly one base station 104. For active mobiles, this is the base station the mobile is currently connected to. For idle mobiles, this is the base station where the last data exchange occurred (e.g., traffic or signaling).

The ownership function 152 can hold additional attributes such as the mobile's present session key, for instance.

The base station serves as a proxy on the LAN for all the mobiles it currently owns. It is therefore the primary data delivery point for downlink packets destined to one of these mobiles. This, again, applies to both active and idle mobiles owned by the base station.

When a base station that does not currently own a given mobile needs information on that mobile and this information is held by the mobile's current owning base station, the non-owning base station can find the mobile's owner through a broadcast message that queries for the mobile's proxy on the LAN. For L2 networks supporting RFC 826, such messaging may be in accordance with ARP. In this case, the mobile's current owning base station responds to this broadcast with a unicast message.

Buffering Function

The buffering function 154 buffers data that arrives on the backhaul interface for a mobile owned by the base station but cannot currently be delivered over the air interface. Since the base station is the primary delivery point for packets addressed to the mobile, it is responsible for buffering such packets in case they cannot be delivered right away. This may happen, for instance, when the mobile is idle and its whereabouts are not known or the mobile is active and undergoes a handover procedure. Note that the buffering function in the present embodiment applies to both idle mode and active mode.

Paging Trigger Function

The paging trigger function 156 invokes execution of a paging strategy by a paging controller when the base station 104 receives downlink data for an idle mobile it owns. When receiving downlink packets for an idle mobile, the base station triggers the paging controller, which executes the paging strategy. The paging controller advises various base stations attached to the LAN to page for the mobile according to the paging strategy. This mechanism is regulated by the corresponding wireless standard. Unlike existing 4G technologies, the present embodiment does not set any limitations on where the paging controller has to reside. This means that it can reside locally on each base station (e.g., within control circuitry 140) or it can reside in a central location (e.g., the MME in LTE).

IP Discovery Function

The IP discovery function 158 allows the base station 104 to discover the IP address of a mobile that is in the process of attaching to the base station via the air interface. This can happen under at least the following circumstances:

1. The base station is the target base station for handover.

2. The mobile performs a tracking area update (TAU).

3. The mobile responds to a page sent by this base station.

4. The mobile attempts to initiate a session at this base station.

5. The mobile connects at this base station.

The IP discovery function is utilized in the present embodiment because air interface signaling occurs on L2 and therefore does not reveal the mobile's IP address. The IP discovery function precedes the ownership claim function. The IP discovery function can retrieve the mobile's IP address from L3 traffic or signaling packets that are sent to or from the mobile. In case such packets are not sent (e.g., in the case of a TAU), the base station can initiate a handshake with the mobile that involves L3 messaging. For example, the base station can send an ICMP Echo Request to the mobile using an L3 broadcast. In this case, the mobile will reply with its IP address.

Ownership Claim Function

The ownership claim function 160 comprises allocation of an ownership cache for an idle or active mobile that associates at the base station 104, allocation of a routing function, and execution of a broadcast message on the backhaul interface that declares the corresponding base station the proxy for this mobile.

The ownership claim function follows after the IP discovery function has been exercised. Ownership can be claimed under at least the following conditions:

1. The base station is the target base station for handover.

2. The mobile performs a TAU.

3. The mobile responds to a page sent by this base station.

4. The mobile attempts to initiate a session at this base station.

5. The mobile connects at this base station.

If any of these cases apply, the base station sends a broadcast message on the DS that makes it the proxy for this mobile. This message automatically updates the data paths for this mobile within the DS. It also unambiguously declares this base station the new owner of the mobile. For systems that support RFC 826, the broadcast message can be a Proxy ARP broadcast message.

Generally, the base station should only claim ownership after proper authentication and resource allocation. For this purpose, it needs information, which may reside at a central location or with the current owning base station.

In the case of active-mode handovers, all information needed about the mobile may be proactively passed from the source base station to the target base station via, for example, an X2/R6 interface. For idle mobiles, 4G technologies provide a mechanism to retrieve this information from a central location (e.g., MME in LTE).

Since the present embodiment introduces explicit ownership for both idle and active mobiles, the mobile's owner can also become the holder of the mobile's information. When an idle mobile attaches to a new base station, this base station can retrieve all information about the mobile from the mobile's current owner instead. For this purpose, the correspondent interface may be supported on the base stations. In LTE, this applies to the S1-MME interface. The present embodiment therefore provides a method to flexibly distribute such control-plane functionality.

Ownership Release Function

The ownership release function 162 releases the proxy function for a mobile under at least the following circumstances:

1. Reception of an ownership claim broadcast at the backhaul interface.

2. Expiration of a specified time interval of mobile inactivity.

The ownership cache can be deleted for this mobile. Further, all entries associated with the routing function can be deleted. Ownership for an idle-mode mobile should expire after a specified time frame unless it is refreshed (e.g., through a TAU). This time frame is a design parameter and should be longer than the typical TAU time interval.

Data Forwarding Function

Upon ownership release, the data forwarding function 164 forwards all traffic buffered by the buffering function 154 for the mobile whose ownership has been released. For this purpose, the traffic is sent out on the backhaul with the proxy address determined by the ownership claim function of the mobile's new owner.

Since the ownership claim message has updated the data delivery path for this mobile, the data can be sent directly, i.e., without a tunnel. Note that a forwarding function already exists in 4G technologies. However, it is only applied to active mobiles and data have to be tunneled instead of being sent directly.

Ownership Ambiguity Resolution

The present embodiment utilizes a potentially ambiguous transport mechanism to switch mobile ownership. It may therefore happen that an ownership claim message is not received at the GW or the current owning base station. Potential ambiguities and their respective resolutions are described below.

1. A base station receives packets for a mobile it does not own (e.g., the packets carry the mobile's IP address and the base station's MAC address). This can happen to in-flight packets after ownership release. The base station can simply forward these packets to the right owner by re-writing the packets' new destination address. If the base station keeps receiving such data for an extended period of time, it may be assumed that either the sender or the receiver of these packets has incorrect ownership cache information. In this case, the receiving base station sends a broadcast request to identify the proxy for this mobile (e.g., through ARP). The legitimate owner responds with a unicast reply. The receiving base station simply forwards the reply to the source of the traffic data.

2. The GW has incorrect cache mapping (e.g., because it did not receive an ownership claim message). In this case it delivers downlink data to the wrong base station which is resolved as noted above.

3. Multiple base stations may believe they own the same mobile. For example, this may happen if the owner of a mobile does not receive the ownership claim message of another base station. If the mobile is active, it can only be connected to one of these two base stations. The other owner considers the mobile idle. Therefore, if data arrive at this latter base station, it triggers a page which is responded through an ownership claim message by the base station where the mobile is currently attached. This resolves the problem. If another base station sends a broadcast message (e.g., through ARP), to resolve the proxy address for the mobile, it receives two or more responses. In this case, that base station picks one of the replies (e.g., the first). If the base station wishes to retrieve data on behalf of the mobile (e.g., keying information), either of the owners are able to respond. If the base station has data to send, it can simply forward that data to either of the owners and the conflict is resolved as described above. If the base station is one to which the idle mobile wishes to attach, that base station will claim ownership which resolves the conflict as well.

FIG. 2 shows a more detailed view of certain elements of the system 100 in an exemplary LTE implementation. In this implementation, mobile 102 corresponds to user equipment (UE) 202, and a given one of the base stations 104 corresponds to enhanced Node B (eNB) 204. The eNB 204 is also considered an illustrative example of “network equipment” as that term is used herein. The eNB 204 is coupled to a GW 208 and a mobility management entity (MME) 212. The GW 208 is also coupled to the MME 212 and to a home subscriber service (HSS) 214. The eNB 204 comprises a processor 220 coupled to a memory 222 and interface circuitry 224. Other system elements, such as UE 202 and GW 208, may each comprise processor, memory and interface circuitry elements, although such elements are not explicitly shown in the figure. Also, certain elements of the system may be combined with others. For example, MME 212 may be implemented within eNB 204 or GW 208. Similarly, HSS 214 may be implemented in another system element, such as GW 208.

The memory 222 of the eNB 204 may be used to store one or more software programs that are executed by the processor 220 to implement at least a portion of the mobility management functionality described herein. For example, at least a portion of one or more of the functional elements 150 of base station 104 may be implemented using software code executed by the processor 220. Also, portions of the circuitry elements 130 may correspond to portions of processor 220, memory 222 and interface circuitry 224.

System memory elements such as memory 222 are examples of what are more generally referred to herein as computer-readable storage media that store executable program code. Such computer-readable storage media may comprise, for example, electronic memory such as random access memory (RAM) or read-only memory (ROM), magnetic memory, optical memory or other types of storage elements, as well as portions or combinations of such elements.

System processor elements such as processor 220 may comprise, for example, microprocessors, microcontrollers, application-specific integrated circuits (ASICs), DSPs, FPGAs or other types of processing devices, as well as portions or combinations of such elements. The associated interface circuitry elements of the system, such as interface circuitry 224 of eNB 204, may comprise transceivers or other communication hardware or firmware that allows the associated system elements to communicate with one another in the manner described herein.

It is apparent from the FIG. 2 arrangement that eNB 204 is configured for connection with GW 208 and vice-versa. Terms such as “connection,” “connection between” and “coupled to” as used herein are intended to be construed generally, and accordingly should not be construed as requiring direct connection between the associated elements. Thus, eNB 204 may be coupled to GW 208 and MME 212 in a given embodiment via one or more other system elements. The same applies for connections between other system elements. Also, as indicated previously, elements such as GW 208, MME 212 and HSS 214 need not be implemented on separate stand-alone processing platforms, but could instead, for example, represent different functional portions of a single common processing platform.

It should again be emphasized that, although FIG. 2 shows an LTE implementation of an illustrative embodiment of the invention, the techniques disclosed herein can be applied to a wide variety of other types of air interfaces, including WiMAX and other present or future air interfaces. Further details regarding LTE can be found in the 3GPP and 3GPP2 specification documents, including, for example, 3GPP2 Specification No. A.S0008-0 v4.0, “Interoperability Specification (IOS) for High Rate Packet Data (HRPD) Radio Access Network Interfaces with Session Control in the Access Network,” May 2007, which are incorporated by reference herein in their entirety. Additional details regarding WiMAX can be found in IEEE Standard 802.16, described in document P802.16Rev2/D5, “Standard for Local and Metropolitan Area Networks, Part 16: Air Interface for Broadband Wireless Access Systems,” June 2008, which is incorporated by reference herein. Other standards governing operation of WiMAX systems are described in WiMAX Forum documents, which are also incorporated by reference herein, including WiMAX Forum Network Architecture—Stage 3—Detailed Protocols and Procedures—Release 1, Version 1.2.3, July 2008.

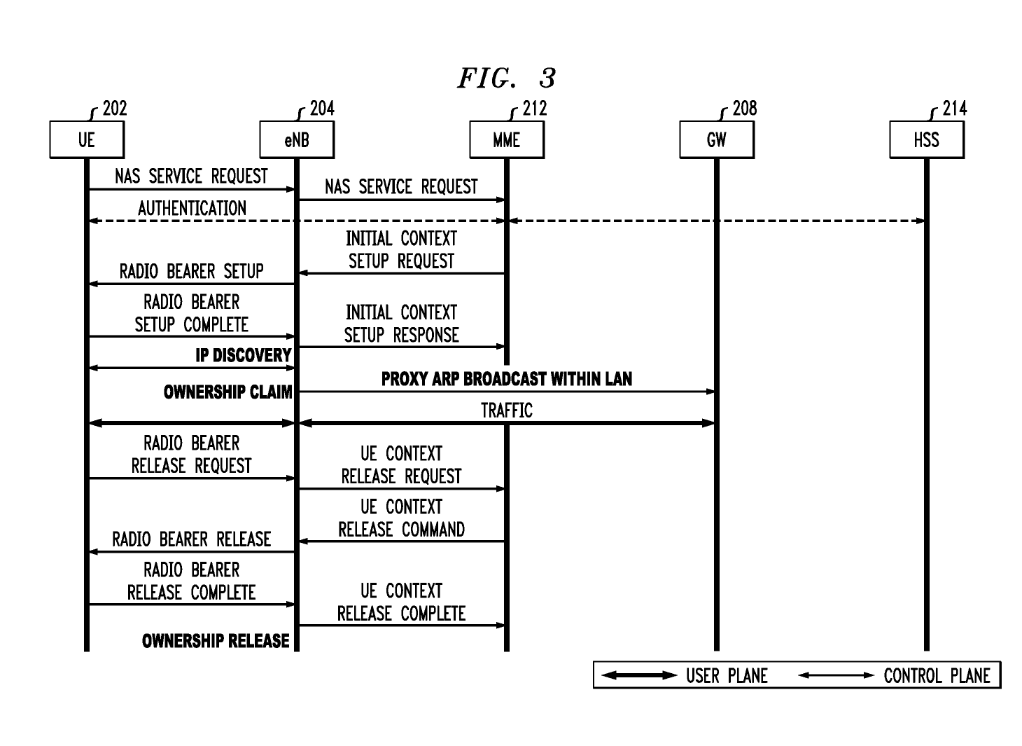

Exemplary signal flows in the LTE implementation of FIG. 2 will now be described with reference to FIGS. 3 through 6. Note that in this example embodiment, the MME provides at least a portion of the control-plane functionality for mobility management, such as paging control and location management. However, such functions can be distributed across the base stations in other embodiments.

FIG. 3 shows an example signal flow for session origination by UE 202. The signal flow is as follows, and all exchanged messages are compliant with 3GPP messaging.

The UE 202 sends a Non-Access-Stratum (NAS) Service Request to the eNB 204 that it wishes to access.

The NAS Service Request is relayed by the eNB to the MME 212.

At this point, an additional Authentication handshake with the HSS 214 may occur to register the UE, as indicated by the dashed line.

The MME responds to the NAS Service Request with an Initial Context Setup Request forwarded to the eNB.

The eNB and UE setup the radio bearer using Radio Bearer Setup and Radio Bearer Setup Complete messages.

The successful radio bearer setup is reported to the MME in an Initial Context Setup Response message.

At this point, the UE has successfully attached to the eNB. The eNB follows by invoking the IP Discovery function 158 to learn the UE's IP address. Then, the eNB declares its ownership on the LAN using the Ownership Claim function 160, which invokes a Proxy ARP broadcast message by the eNB on the LAN. This message creates the forwarding path on GW 208 and all other eNBs on behalf of this UE.

After this message, traffic can be sent and received by the UE.

When the UE 202 detaches from the eNB 204, the signal flow is as follows, again using 3GPP-compliant messages.

The UE sends a Radio Bearer Release Request message to the eNB.

The eNB sends a UE Context Release Request to the MME.

The MME responds with a UE Context Release Command to the eNB.

The eNB and UE release the radio bearer using Radio Bearer Release and Radio Bearer Release Complete messages.

The successful radio-bearer release is reported to the MME in the UE Context Release Complete response.

After successful radio bearer release, the eNB invokes the Ownership Release function 162. Note that Ownership Release does not require any update on the LAN. Such an update is not necessary since all routers attached to the LAN (e.g., eNBs and GW) hold the mapping between the mobile's IP address and eNB's MAC address in a cache subject to expiration after a specified time frame.

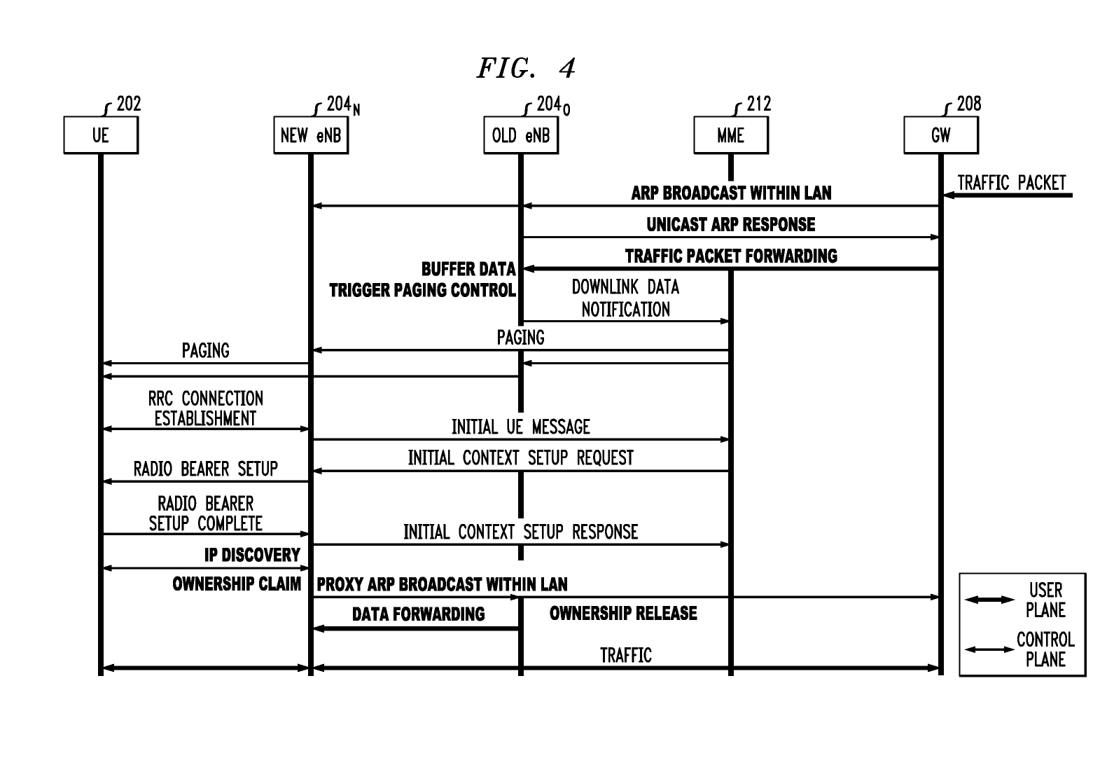

FIG. 4 shows an example signal flow for session termination by the UE 202, and generally indicates the processing when data arrive at the GW 208 for the UE when the UE is in its idle mode. The old owner of the UE is referred to as Old eNB 204_{O} and the new owner of the UE is referred to as New eNB 204_{N}.

At the beginning of the FIG. 4 signal flow, a traffic packet arrives at the GW 208 destined for UE 202. It is assumed that the UE has been idle for some time, and that the GW cache entry for that UE has expired. The GW sends an ARP broadcast on the LAN, and a corresponding unicast response is received from the Old eNB 204_{O}. This allows the GW to forward the traffic packet to the Old eNB.

Upon arrival of the traffic data, the Old eNB invokes the Data Buffering function 154 and buffers the traffic data. It also invokes the Paging Trigger function 156. In this embodiment, the paging controller is assumed to reside on the MME.

The signal flow then proceeds as follows, using 3GPP-compliant messages:

The Old eNB sends a Downlink Data Notification message to the MME, which triggers the paging controller.

The MME sends Paging messages to various eNBs within the LAN according to a paging strategy.

The corresponding eNBs each send a Paging message on the air interface containing the UE's identifier.

The UE, which is assumed to be located in the cell of the New eNB, undergoes an RRC Connection Establishment handshake with the New eNB.

The New eNB sends an Initial UE message to the MME. At this point in time, the Old eNB is still the UE's owner.

The MME responds to the New eNB with an Initial Context Setup Request.

The New eNB and the UE set up a radio bearer using the Radio Bearer Setup and Radio Bearer Setup Complete messages.

The New eNB sends an Initial Context Setup Response message to the MME.

At this point, the New eNB invokes the IP Discovery function 158 to learn the UE's IP address. Then, the New eNB invokes the Ownership Claim function 160 and sends a Proxy ARP broadcast within the LAN. This updates the data path for the UE.

Upon reception of the Proxy ARP, the Old eNB invokes the Ownership Release function 162 and the Data Forwarding function 164. Since the Proxy ARP has created a new path for the UE, the Old eNB can forward the buffered data directly to the New eNB.

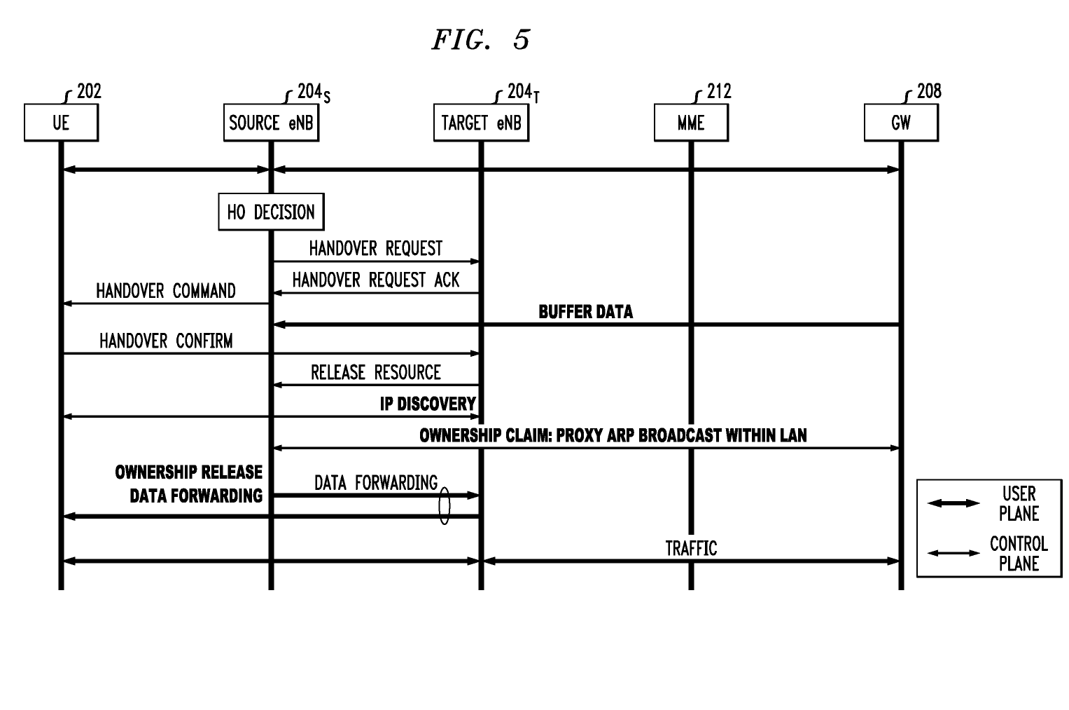

FIG. 5 shows an example signal flow for an X2 handover within the LAN. At the beginning of the signal flow, the UE 202 is assumed to be in its active mode and initially connected to a Source eNB 204_{S}. Based on measurements reported by the UE, the Source eNB decides to hand the UE over to a Target eNB 204_{T}. At this point the Source eNB is the owner of the UE.

The signal flow then proceeds as follows, using 3GPP-compliant messages:

The Source eNB sends a Handover Request to the Target eNB.

The Target eNB acknowledges the request with a Handover Request Ack message.

Traffic data arriving from the network destined for the UE are meanwhile buffered by the Source eNB.

The Source eNB sends a Handover Command to the UE.

The UE confirms this message by sending a Handover Confirm to the Target eNB.

The Target eNB sends a Release Resource message to the Source eNB.

At this point, the Target eNB invokes the IP Discovery function 158 to learn the UE's IP address. Then it invokes the Ownership Claim function 160, which sends a Proxy ARP broadcast within the LAN. This updates the data path for the UE.

Upon reception of the Proxy ARP, the Source eNB invokes the Ownership Release function 162 and the Data Forwarding function 164. Since the Proxy ARP has created a new path for the UE, the Source eNB can forward the buffered data directly to the Target eNB.

In this exemplary signal flow, the Data Forwarding function of the Source eNB is used to forward data to the Target eNB. This function should not be exercised before the Ownership Claim function has been exercised by the Target eNB since the latter function sets the new path for the UE. It should also be noted that LTE also provides data forwarding mechanisms via X2, which can be used until the Ownership Claim function has been exercised.

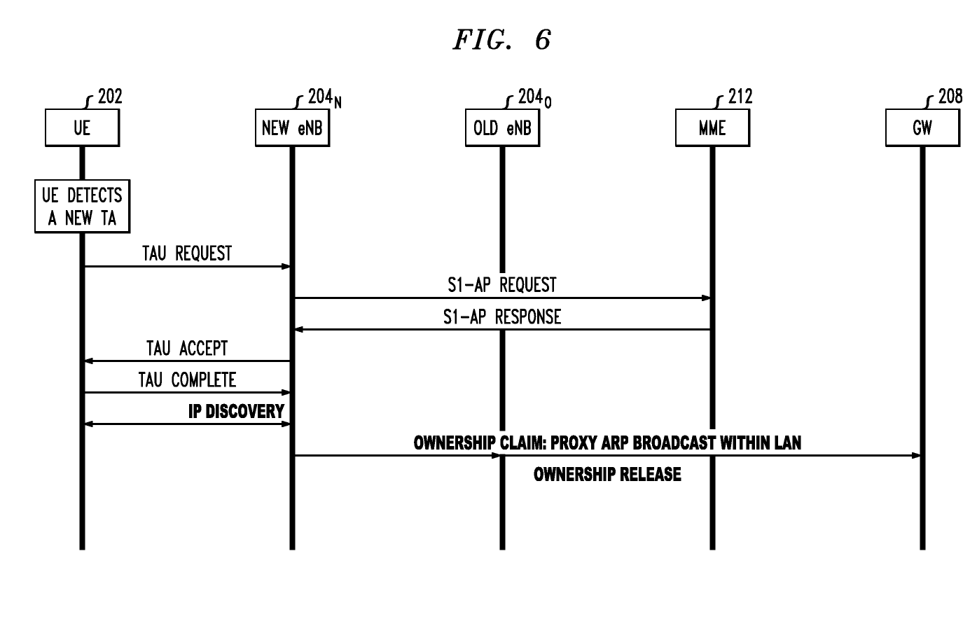

FIG. 6 shows an example signal flow for a tracking area update (TAU). A TAU may be initiated by the UE 202 upon entering a new tracking area, or periodically otherwise. At the beginning of the signal flow, it is assumed that the UE is in idle mode and its current owner is referred to as Old eNB 204_{O}. The UE, however, resides in the cell associated with New eNB 204_{N}.

The signal flow then proceeds as follows, using 3GPP-compliant messages:

The UE sends a TAU Request to the New eNB.

The New eNB sends an S1-AP Request to the MME.

The MME replies with an S1-AP Response to the New eNB.

The New eNB sends a TAU Accept to the UE.

The UE replies with a TAU Complete to the New eNB.

At this point, the New eNB invokes the IP Discovery function 158 to learn the UE's IP address, followed by the Ownership Claim function 160, which sends a Proxy ARP broadcast within the LAN. This updates the data path for the UE.

Upon reception of the Proxy ARP, the Source eNB invokes the Ownership Release function 162.

It is to be appreciated that the particular signal flows shown in FIGS. 3 through 6 are presented by way of illustrative example only, and that alternative embodiments may utilize other types of messages, communication sequences and function invocations.

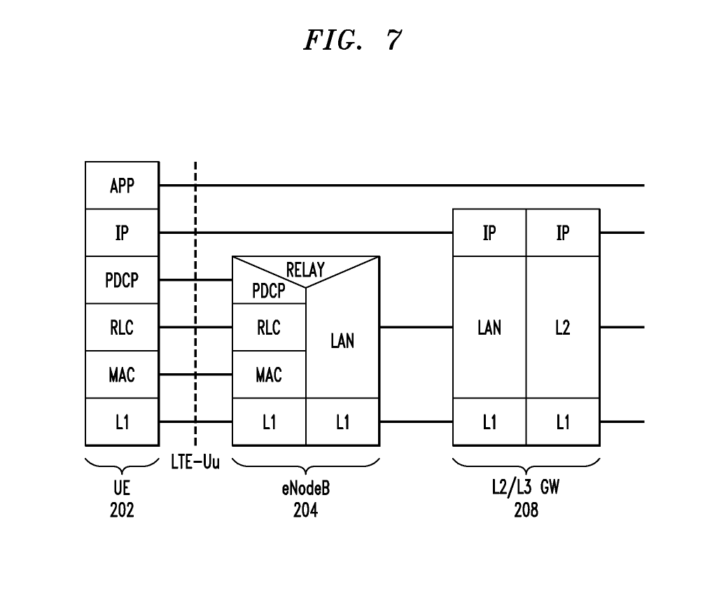

FIG. 7 shows an exemplary user plane protocol stack for the UE 202, eNB 204 and GW 208 of the LTE implementation of FIG. 2. The UE 202 includes Layer 1 (L1), Medium Access Control (MAC), Radio Link Control (RLC), Packet Data Convergence Protocol (PDCP), IP and application layers. The L1, MAC, RLC and PDCP layers of the UE interface with corresponding layers of the eNB 204. The eNB also includes L1 and LAN layers that interface with corresponding layers of the GW 208. The GW includes an IP layer that interfaces with the IP layer of the UE, and L1, L2 and IP layers that interface with corresponding layers of an L3 network such as Internet 110.

Alternative embodiments of the invention can be configured which utilize different arrangements of system elements and communication protocols than those described above. For example, the LANs 106 can utilize any other Layer 2 protocol in place of Ethernet. Also, the broadcast signaling messages for address resolution can be based on ARP in IPv4 (RFC 823), the Neighbor Discovery Protocol in IPv6 (RFC 2461), or other broadcast protocols. The LAN 106 can also be replaced by an L3 network where routing updates are provided via broadcast messages supported by the routing protocol such as RIP or OSPF. In this case the corresponding broadcast messages for address resolution and proxy function may be part of the routing protocol.

As another example, multiple IP domains can be overlaid through a VLAN structure. This allows each mobile to simultaneously carry multiple IP addresses pertaining to the different domains. The various domains can be supported by different GWs. Also, the disclosed techniques can be extended to macro-cellular networks by permitting multiple adjacent LANs or VLANs and supporting cross-LAN or cross-VLAN handovers via L3 mobility technologies such as Mobile IP, HIP, NMIP or others. In addition, handoff between traffic on the LAN and an LTE or WiMAX network can be supported via Mobile IP. Mobile IP comes in two primary versions namely Mobile IPv4 (RFC 3344) and Mobile IPv6 (RFC 3775). There are additional versions such as Proxy Mobile IP (RFC 5213) and Dual Stack Mobile IP etc. Mobile IP generally supports mobility in form of an overlay network on L3. HIP is an IETF proposal (RFC 5210) that supports host-based mobility on L3.

The illustrative embodiments provide significant advantages relative to conventional systems. For example, these embodiments do not require mobility anchors, nor do they require an IP address change at every mobility event. Data traffic can be forwarded directly, without the need for tunnels. Also, the disclosed techniques are compliant with standard air interfaces, such as LTE or WiMAX, and therefore no changes are required to the mobiles or to Layer 2 or Layer 3 network devices. The disclosed techniques allow realization of cost-effective wireless LANs that support these standard 4G air interfaces.

It should again be emphasized that the various embodiments described herein are presented by way of illustrative example only, and should not be construed as limiting the scope of the invention. For example, alternative embodiments of the invention can utilize different communication system configurations and components, network equipment, air interfaces, broadcast-based backhaul networks, messaging protocols, and mobility management functions than those described above in the context of the illustrative embodiments. These and numerous other alternative embodiments within the scope of the appended claims will be readily apparent to those skilled in the art.

What is claimed is:

1. An apparatus comprising:
network equipment comprising a backhaul interface for communicating with a broadcast-based backhaul network and an air interface for communicating with a plurality of mobiles;
wherein the network equipment is configured to serve as a proxy on the broadcast-based backhaul network for at least a given one of the mobiles that communicates with the network equipment over the air interface, by determining an IP address for the given mobile and sending a broadcast message over the broadcast-based backhaul network advertising itself as said proxy in association with said IP address.

2. The apparatus of claim 1 wherein the network equipment comprises at least a portion of a base station.

3. The apparatus of claim 2 wherein the broadcast-based backhaul network interconnects the base station with a plurality of other base stations and at least one gateway coupled to another network.

4. The apparatus of claim 1 wherein the network equipment is configured to support both idle mode and active mode functionality on the air interface for the given mobile.

5. The apparatus of claim 4 wherein the network equipment is configured to permit a data delivery path to be established to the given mobile regardless of whether that mobile is in an active state or an idle state.

6. The apparatus of claim 5 wherein the network equipment is configured to respond to an additional broadcast message from other network equipment connected to the broadcast-based backhaul network in order to establish the data delivery path to the given mobile in its active state or idle state.

7. The apparatus of claim 1 wherein the broadcast-based backhaul network comprises a local area network that operates in accordance with an Ethernet protocol, the air interface comprises one of an LTE air interface and a WiMAX air interface, and the broadcast message comprises a proxy broadcast message of an address resolution protocol.

8. The apparatus of claim 1 wherein the network equipment is configured to implement an ownership function for at least a subset of the plurality of mobiles including the given mobile, with said ownership function comprising, for each of the mobiles in the subset, stored information indicating if that mobile is in an active mode or an idle mode, a data routing function for that mobile, and a proxy function for that mobile.

9. The apparatus of claim 8 wherein the network equipment is configured to implement an ownership claim function that when asserted with reference to a mobile not in the subset causes that mobile to be added to the subset.

10. The apparatus of claim 8 wherein the network equipment is configured to implement an ownership release function that when asserted with reference to a mobile in the subset causes that mobile to be removed from the subset.

11. The apparatus of claim 9 wherein the network equipment is configured to send the broadcast message over the broadcast-based backhaul network in conjunction with assertion of the ownership claim function for the given mobile.

12. The apparatus of claim 8 wherein the network equipment is configured to implement a data buffering function for storing data received over the backhaul interface and destined for at least one mobile in the subset that is not currently able to receive said data.

13. The apparatus of claim 8 wherein the network equipment is configured to implement a paging trigger function for controlling generation of one or more paging messages for at least one mobile in the subset for which data is received over the backhaul interface while that mobile is in the idle mode.

14. The apparatus of claim 9 wherein the network equipment is configured to implement an IP discovery function that is asserted prior to assertion of the ownership claim function for the given mobile and allows the network equipment to determine the IP address of the given mobile.

15. The apparatus of claim 10 wherein the network equipment is configured to implement a data forwarding function that is asserted subsequent to assertion of the ownership release function for the given mobile and causes buffered received data for that mobile to be forwarded to other network equipment that has asserted an ownership claim function for that mobile.

16. The apparatus of claim 8 wherein the network equipment is configured to implement an ownership ambiguity resolution function that resolves ambiguities in ownership among multiple network equipment for the given mobile.

17. The apparatus of claim 8 wherein the network equipment is configured to alter the subset of mobiles, in response to an indication of a mobility-related event, by adding at least one mobile to the subset or removing at least one mobile from the subset, and wherein said mobility-related event comprises a handover in active mode, a tracking area update, or a session initiation in idle mode.

18. The apparatus of claim 1 wherein the network equipment further comprises:
a processor; and
a memory coupled to the processor;
wherein the processor is configured to control performance of said determining of the IP address and said sending of the broadcast message over the broadcast-based backhaul network, responsive to program code stored in said memory.

19. A method comprising:
determining in network equipment an IP address for a mobile that communicates with the network equipment over an air interface; and
sending a broadcast message, over a broadcast-based backhaul network coupled to the network equipment, that advertises the network equipment as a proxy for the mobile in association with said IP address.

20. A computer-readable storage medium having embodied therein executable program code that when executed by a processor of the network equipment causes the network equipment to perform the steps of the method of claim 19.

21. A communication system comprising:
a broadcast-based backhaul network; and
at least first and second network equipment coupled to said broadcast-based backhaul network;
each of said first and second network equipment being configured to communicate with one or more mobiles over an air interface;
wherein at least a given one of said first and second network equipment determines an IP address for one of said mobiles that communicates with the given network equipment, and sends a broadcast message over said broadcast-based backhaul network that advertises the given network equipment as a proxy for that mobile in association with the determined IP address.
